(19) United States
(12) Patent Application Publication
(10) Pub. No.: US 2005/0071337 A1
(43) Pub. Date: Mar. 31, 2005

(54) Encryption of query execution details in a database management system

(75) Inventors: Shawn Joseph Baranczyk, Rochester, MN (US); Brian Robert Muras, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, Armonk, NY (US)

(21) Appl. No.: 10/671,343

(22) Filed: Sep. 25, 2003

(51) Int. Cl. G06F 12/14

(52) U.S. Cl. 707/9; 713/193

(57) ABSTRACT

An apparatus, program product and method log execution of a query in a database management system with one or more execution details encrypted to restrict access to those execution details by unauthorized parties. Execution details such as SQL statements, and values passed to parameter markers and/or host variables associated with the queries executed on a database management system may therefore be kept confidential and made accessible only to authorized parties able to decrypt the execution details.

### FIELD OF THE INVENTION

The invention relates to database management systems, and in particular, to database monitoring and execution logging in database management systems.

### BACKGROUND OF THE INVENTION

Databases are used to store information for an innumerable number of applications, including various commercial, industrial, technical, scientific and educational applications. As the reliance on information increases, both the volume of information stored in most databases, as well as the number of users wishing to access that information, likewise increases. Moreover, as the volume of information in a database, and the number of users wishing to access the database, increases, the amount of computing resources required to manage such a database increases as well.

Database management systems (DBMS's), which are the computer programs that are used to access the information stored in databases, therefore often require tremendous resources to handle the heavy workloads placed on such systems. As such, significant resources have been devoted to increasing the performance of database management systems with respect to processing searches, or queries, to databases.

Improvements to both computer hardware and software have improved the capacities of conventional database management systems. For example, in the hardware realm, increases in microprocessor performance, coupled with improved memory management systems, have improved the number of queries that a particular microprocessor can perform in a given unit of time. Furthermore, the use of multiple microprocessors and/or multiple networked computers has further increased the capacities of many database management systems. From a software standpoint, the use of relational databases, which organize information into formally-defined tables consisting of rows and columns, and which are typically accessed using a standardized language such as Structured Query Language (SQL), has substantially improved processing efficiency, as well as substantially simplified the creation, organization, and extension of information within a database.

One tool that is often supported in a database management system to assist in maximizing the performance of the system in a particular installation is that of a database monitor (DBMON). A database monitor, when enabled, is used to generate an execution log that records each query issued and processed by a database management system. For each logged query, the database monitor typically stores a number of execution details, including, for example, the type of access plan used to execute the query, the time and amount of resources used to execute the query, what indexes and other available resources were used during execution of the query, the number of records returned as a result of the query, etc. Often, the execution log is stored in the format of one or more database records, which can then be retrieved at a later time using a viewer program to analyze the performance of the database management system.

A database monitor execution log can be used to identify sub-optimal system settings to permit those settings to be adjusted to improve performance. Moreover, an execution log may be used to identify the potential for other performance gains, e.g., to identify particular tables that are accessed with enough frequency to warrant the creation of additional indexes.

Still another use for an execution log is to optimize particular queries. Often, the manner in which individual queries are composed can significantly affect the performance of a DBMS in handling that query. Thus, by analyzing the execution log for a particular query, it may be possible to identify how to alter the original query to improve its execution on the database management system.

In addition to the aforementioned execution details, additional execution details that are often output to an execution log include the actual query statement (e.g., the actual SQL text for the query, or a prepared SQL statement automatically generated for a query), as well as host variables and parameter markers used or incorporated in the query. A host variable is typically a variable defined in a host language, or that is generated by an SQL precompiler, and represents data to be inserted into the query during execution. A parameter marker, which is similar in function to a host variable, is typically used in dynamic SQL statements to represent positions in an SQL statement where data is to be inserted by an application.

It has been found, however, that in some instances, some of the execution details logged in an execution log by a database monitor may contain confidential information that a party may not wish to have accessible by others. For example, some execution details such as the values passed to parameter markers or host variables during execution of a query may include confidential information such as employee social security numbers, salary information, etc. It is understandable that in such instances, a company would rather not have its systems administrators or any others having access to its databases be able to view this confidential information.

As another example, the query statements themselves may be confidential to an application developer. Some application developers expend substantial resources, for example, to develop complex SQL statements that perform complex operations in a highly tuned manner. These statements themselves may provide a significant competitive advantage and represent a valuable intellectual asset of the developer, and as a result, the developer would rather not have the text of such statements available to customers or competitors.

Conventional database monitors, however, typically log all execution details for an executed query execution in an execution log, without regard to the type of execution detail. While database monitoring may be disabled, disabling monitoring results in no execution details being logged at all. As a result, a significant need exists for a manner of protecting confidential information associated with the execution of database queries from undesirable exposure as a result of execution logging in a database management system.

### SUMMARY OF THE INVENTION

The invention addresses these and other problems associated with the prior art by providing an apparatus, program product and method that log execution of a query in a database management system with one or more execution details encrypted or otherwise scrambled to restrict access to those execution details by unauthorized parties. As a result, execution details such as the actual query statements, and values passed to parameter markers and/or host variables associated with the queries executed on a database management system may be kept confidential and accessible only to authorized parties having the ability to decrypt the execution details.

Therefore, consistent with the invention, query execution may be logged in a database management system by generating an encrypted representation of an execution detail for a query executed by the database management system, and logging the execution detail for the query in an execution log for the database management system by storing the encrypted representation thereof in the execution log.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described exemplary embodiments of the invention.

### BRIEF DESCRIPTION OF THE DRAWINGS

FIG. 1 is a block diagram of a networked computer system incorporating a database management system within which is implemented execution log encryption consistent with the invention.

FIG. 2 is a block diagram illustrating the principal components and flow of information therebetween in the database management system of FIG. 1.

FIG. 3 is a flowchart illustrating the program flow of a process incoming query routine executed by the database management system of FIG. 1.

FIG. 4 is a flowchart illustrating the program flow of a read database monitor log routine executed by the database management system of FIG. 1.

### DETAILED DESCRIPTION

The embodiments discussed hereinafter log query execution in an execution log for a database management system by encrypting selected execution details associated with such queries to inhibit undesirable access to such execution details by unauthorized parties. While the types of execution details that may be encrypted may vary in different embodiments, typically the types of execution details that may be desirable to encrypt include details such as query statements, values passed to host variables, values passed to parameter markers, and other execution details that may disclose either the program code associated with a query, or the data used during execution of the query.

Moreover, it will be appreciated that while all execution details associated with a query execution may be encrypted in the manner disclosed herein, in many embodiments it is desirable to encrypt only a subset of the execution details, leaving unencrypted other types of execution details such as the types of access plans used to execute queries (e.g., join orders, what indexes and other available resources were used, and other access plan information), various performance statistics (e.g., the time and amount of resources used to execute queries and the number of records returned as a result of queries), optimizer recommendations (e.g., suggested indices and resource configuration changes), etc.

It will also be appreciated that encryption of execution details may be set globally, such that all queries are logged in an identical manner, or in the alternative, what execution details are encrypted may be set to treat different queries differently, e.g., based upon job, user, query type, etc. A user, administrator or application may be permitted to configure a database monitor to add or remove execution detail types from the types of execution details that are encrypted. Furthermore, different users may be granted different access rights to different types of execution details, e.g., so that one type of user can access certain execution details that are not accessible by other users.

In addition, while the illustrated implementation discussed below relies on public key encryption, where a public key is used to encrypt execution details, and an associated private key is used to decrypt those execution details, other encryption schemes may be used to encrypt execution details consistent with the invention. The invention is therefore not limited to the particular implementations discussed herein.

Turning now to the Drawings, wherein like numbers denote like parts throughout the several views, FIG. 1 illustrates an exemplary hardware and software environment for an apparatus 10 suitable for implementing a database management system incorporating execution detail encryption consistent with the invention. For the purposes of the invention, apparatus 10 may represent practically any type of computer, computer system or other programmable electronic device, including a client computer, a server computer, a portable computer, a handheld computer, an embedded controller, etc. Moreover, apparatus 10 may be implemented using one or more networked computers, e.g., in a cluster or other distributed computing system. Apparatus 10 will hereinafter also be referred to as a “computer,” although it should be appreciated the term “apparatus” may also include other suitable programmable electronic devices consistent with the invention.

Computer 10 typically includes a central processing unit (CPU) 12 including one or more microprocessors coupled to a memory 14, which may represent the random access memory (RAM) devices comprising the main storage of computer 10, as well as any supplemental levels of memory, e.g., cache memories, non-volatile or backup memories (e.g., programmable or flash memories), read-only memories, etc. In addition, memory 14 may be considered to include memory storage physically located elsewhere in computer 10, e.g., any cache memory in a processor in CPU 12, as well as any storage capacity used as a virtual memory, e.g., as stored on a mass storage device 16 or on another computer coupled to computer 10.

Computer 10 also typically receives a number of inputs and outputs for communicating information externally. For interface with a user or operator, computer 10 typically includes a user interface 18 incorporating one or more user input devices (e.g., a keyboard, a mouse, a trackball, a joystick, a touchpad, and/or a microphone, among others) and a display (e.g., a CRT monitor, an LCD display panel, and/or a speaker, among others). Otherwise, user input may be received via another computer or terminal, e.g., via a client or single-user computer 20 coupled to computer 10 over a network 22. This latter implementation may be desirable where computer 10 is implemented as a server or other form of multi-user computer. However, it should be appreciated that computer 10 may also be implemented as a standalone workstation, desktop, or other single-user computer in some embodiments.

For non-volatile storage, computer 10 typically includes one or more mass storage devices 16, e.g., a floppy or other removable disk drive, a hard disk drive, a direct access storage device (DASD), an optical drive (e.g., a CD drive, a DVD drive, etc.), and/or a tape drive, among others. Furthermore, computer 10 may also include an interface 24 with one or more networks 22 (e.g., a LAN, a WAN, a wireless network, and/or the Internet, among others) to permit the communication of information with other computers and electronic devices. It should be appreciated that computer 10 typically includes suitable analog and/or digital interfaces between CPU 12 and each of components 14, 16, 18, and 24 as is well known in the art.

Computer 10 operates under the control of an operating system 26, and executes or otherwise relies upon various computer software applications, components, programs, objects, modules, data structures, etc. For example, a database management system (DBMS) 28 may be resident to access a database 30, and may include a database monitor 32 for generating an execution log, which in the illustrated implementation is also stored in database 30 (although the execution log may be stored separately from database 30 in other implementations of the invention. Queries issued to DBMS 28 by one or more applications 34 are processed by DBMS 28 to retrieve search results from database 30. Moreover, monitor 32 logs the execution of such queries in the aforementioned execution log, with selective encryption performed on certain execution details associated with such queries. As will become more apparent below, computer program code, e.g., implemented in a viewer 36, may be used to retrieve the execution details, with decryption performed on any encrypted execution details as appropriate.

Moreover, various applications, components, programs, objects, modules, etc. may also execute on one or more processors in another computer coupled to computer 10 via a network, e.g., in a distributed or client-server computing environment, whereby the processing required to implement the functions of a computer program may be allocated to multiple computers over a network.

In general, the routines executed to implement the embodiments of the invention, whether implemented as part of an operating system or a specific application, component, program, object, module or sequence of instructions, or even a subset thereof, will be referred to herein as “computer program code,” or simply “program code.” Program code typically comprises one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of computer readable signal bearing media used to actually carry out the distribution. Examples of computer readable signal bearing media include but are not limited to recordable type media such as volatile and non-volatile memory devices, floppy and other removable disks, hard disk drives, magnetic tape, optical disks (e.g., CD-ROMs, DVDs, etc.), among others, and transmission type media such as digital and analog communication links.

In addition, various program code described hereinafter may be identified based upon the application within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the specific organization and allocation of program functionality described herein.

Those skilled in the art will recognize that the exemplary environment illustrated in FIG. 1 is not intended to limit the present invention. Indeed, those skilled in the art will recognize that other alternative hardware and/or software environments may be used without departing from the scope of the invention.

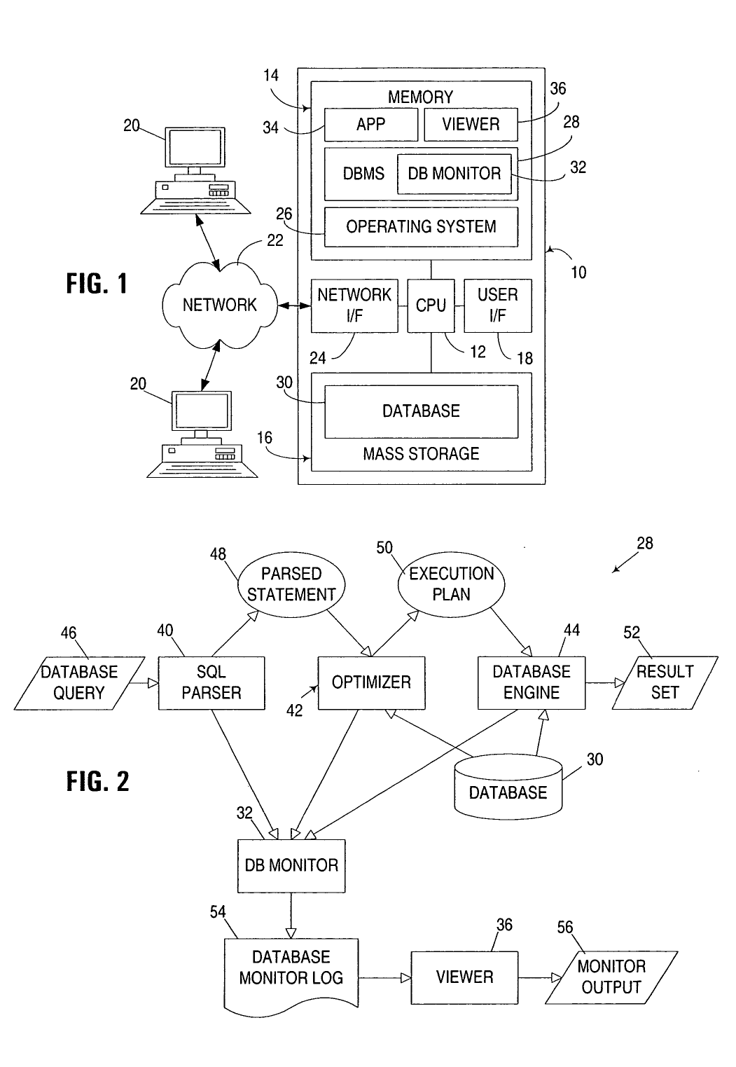

FIG. 2 next illustrates in greater detail the principal components in one implementation of DBMS 28. The principal components of DBMS 28 that are generally relevant to query execution are an SQL parser 40, optimizer 42 and database engine 44. SQL parser 40 receives from a user (or more typically, an application executed by that user) a database query 46, which in the illustrated embodiment, is provided in the form of an SQL statement. SQL parser 40 then generates a parsed statement 48 therefrom, which is passed to optimizer 42 for query optimization. As a result of query optimization, an execution or access plan 50 is generated. Once generated, the execution plan is forwarded to database engine 44 for execution of the database query on the information in database 30. The result of the execution of the database query is typically stored in a result set, as represented at block 52.

Execution logging in the embodiment of FIG. 2 is centralized within database monitor 32 in the database management system, which collects execution detail data from SQL parser 40, optimizer 42 and database engine 44, and stores such data in a database monitor or execution log 54. Log 54 may be stored in database 30 or may be stored separately from database 30.

Viewer 36 is used to read and display the contents of log 54, output as shown at block 56 in FIG. 2. In different embodiments, viewer 36 may be incorporated into DBMS 28, or may be an external program. Moreover, viewer 36 may be resident on a client computer, rather than a server computer, and may access log 54 via issuing queries to database 30.

Consistent with the invention, database monitor 32 is configured to selectively encrypt execution details output to log 54, and viewer 36 is configured to decrypt when appropriate any encrypted execution details. In the illustrated embodiment, such encryption/decryption may utilize public/private key pairs, with a public key available to monitor 32 used to encrypt execution details, and a private key available to viewer 36 used to decrypt the encrypted execution details.

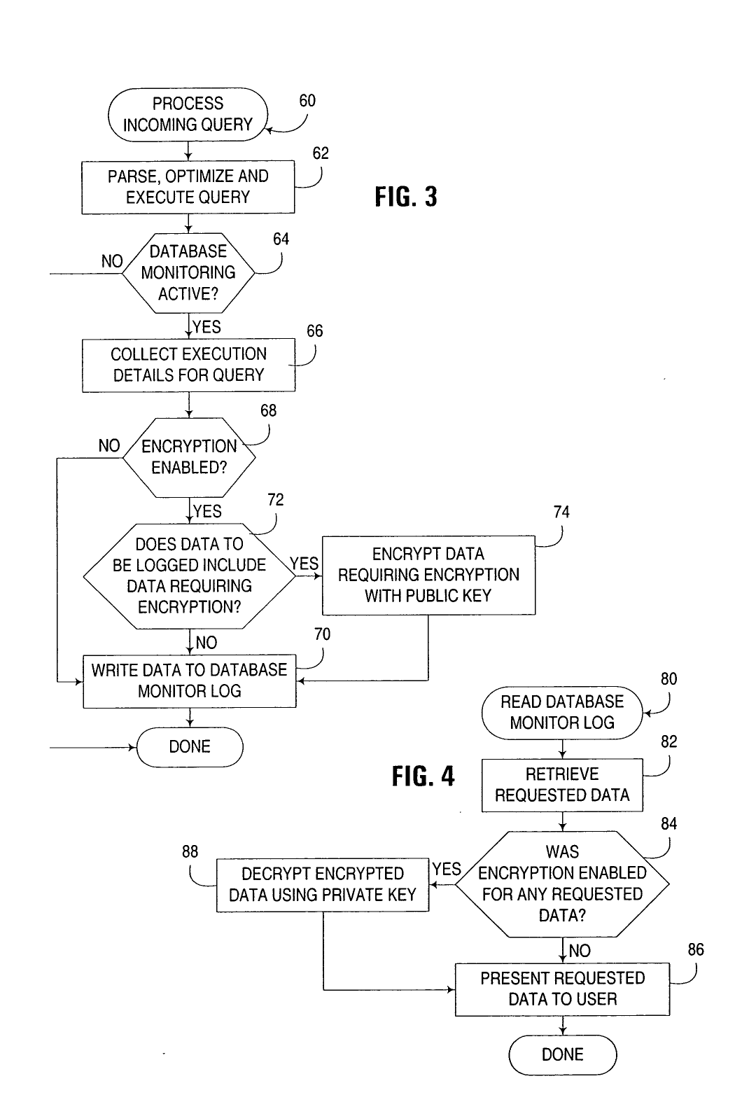

Now turning to FIG. 3, an exemplary process incoming query routine 60 is illustrated. Routine 60 is executed by DBMS 28 in response to receiving a query from a user or application. In the illustrated implementation, block 62 of routine 60 is collectively performed by blocks 40, 42 and 44 of DBMS 28, while the remainder of the blocks are performed by database monitor 32.

Routine 60 begins in block 62 by parsing, optimizing and executing an incoming query, in a manner generally known in the art. Next, block 64 determines whether database monitoring is currently active. If not, routine 60 simply terminates. Otherwise, control passes to block 66 to collect execution details associated with the execution of the query. Next, block 68 determines whether encryption is enabled. If not, control passes to block 70 to simply write the collected execution detail data to the database monitor log in unencrypted form, and completing processing of the query.

Otherwise, if encryption is enabled, block 68 passes control to block 72 to determine whether any data to be logged includes any data requiring encryption, e.g., any execution details for which encryption is desired. If not, control passes to block 68 to write the collected execution detail data to the database monitor log, without any of such data encrypted. Otherwise, block 68 passes control to block 74 to encrypt the appropriate execution detail data using a public key provided to the database monitor, and thus generating an encrypted representation thereof, prior passing control to block 70 to write the encrypted execution detail data (along with any additional non-encrypted data) to the database monitor log. Upon completion of block 70, routine 60 is complete.

A complementary read database monitor log routine 80 is illustrated in FIG. 4. Routine 80 may be resident, for example, in viewer 36, and may operate by issuing queries to database 30 to retrieve the execution details for one or more executed queries logged on database monitor log 54.

Routine 80 begins in block 82 by retrieving the requested data, which may be specified, for example, by a user interacting with viewer 36. Once the requested data is retrieved, control passes to block 84 to determine whether encryption was enabled for any of the requested data, e.g., by determining whether encryption was enabled for the database monitor, and if so, whether the particular requested data incorporates any encrypted data. Determining whether requested data incorporates encrypted data may be performed, for example, by querying a column in the execution log. It may be desirable in such an implementation to store the public key used to encrypt the data in the column when the data is encrypted, and to leave the column blank if the data is unencrypted.

If no encrypted data is incorporated into the requested data, control passes to block 86 to present the requested data to the user, whereby routine 80 is complete. Otherwise, if encrypted data is present, block 84 passes control to block 88 to decrypt any such encrypted data using the related private key. Control then passes to block 86 to output the now-decrypted data (along with any non-encrypted data) as the results of the user's query of the execution log. Routine 80 is then complete.

In one implementation of the invention, e.g., as implemented on an eServer iSeries computer from International Business Machines Corporation, encryption of execution details may be implemented within the DBMON database monitor in the DB2 DBMS. In such an implementation, the database monitor can be enabled or disabled by a user, and as such, encryption may only be performed when the monitor is enabled.

Moreover, encryption of execution details may be enabled through user selection, e.g., by setting an environment variable or creating a file or object with a designated identifier. Moreover, the public key required to encrypt the execution details may be provided in the environment variable or created file or object, such that, when the database monitor attempts to determine whether encryption is enabled, the public key required to perform such encryption may be retrieved.

Furthermore, in connection with enabling encryption, a user may specify what types of execution details should be encrypted, e.g., SQL statements or other query program code, values passed to host variables, values passed to parameter markers, or combinations of the same. In the alternative, the types of execution details to be encrypted may be hard coded.

In the aforementioned iSeries implementation, public key information may be stored by an application in a data area called SQL_Scrambler within the QTEMP environment variable, the latter of which being a temporary, private library associated with every job in the system. The data area may contain character data such as “$SQL_SCRAMBLE_DBMON_PUBLIC_KEY=xxxx”, where “xxxx” is the public key to be used. The application provider that provided the key would then be responsible for creating the data area within any jobs within which the application runs, entering the correct public key, and holding a lock on the data area to prevent deletion by an unauthorized party. The DBMS may then, when processing a query, first check to see if monitoring is enabled, and if so, check for the existence of the QTEMP/SQL_Scrambler data area. If such a data area exists, the database monitor may then use the public key to encrypt the desired data, and then write the encrypted data, along with any additional non-encrypted data, to the execution log.

Thereafter, if the application provider or another party needed to access the encrypted data, e.g., to debug the query, the private key may be used to do so. It is anticipated that such functionality may be implemented within a viewer if desired. It should also be appreciated, however, that for any other execution detail data that is not encrypted, no private key would be required.

Various modifications may be made to the illustrated embodiments consistent with the invention. For example, in embodiments where a query statement is communicated over a network from an application to a database management system, rather than being communicated internally via an API or other interface, it may be desirable to encrypt information regarding a query, e.g., the query statement itself, prior to communicating the query to the database management system. In such an embodiment the database management system may include the appropriate private key suitable for decrypting the statement prior to parsing, optimizing and executing the query. Furthermore, in such an implementation, logging of the query statement in a database monitor log would not require that encryption be performed on the statement by the database management system, only that the encrypted representation received from the application or user be stored in the log. By doing so, interception of the query statement on the network may be avoided, in addition to inhibiting discovery via the execution log.

In addition, it will be appreciated that encryption schemes other than public/private key pairs may be used to encrypt execution details consistent with the invention. For example, symmetric key encryption, whereby the parties agree on the keys beforehand, may be used in some implementations.

Additional modifications may be made to the illustrated embodiments without departing from the spirit and scope of the invention. Therefore, the invention lies in the claims hereinafter appended.

1. A method of executing a query in a database management system, the method comprising:
receiving an SQL statement from an application program coupled to the database management system;
executing the SQL statement;
encrypting the SQL statement to generate an encrypted representation of the SQL statement; and
logging execution of the SQL statement in a database monitor by storing the encrypted representation of the SQL statement in an execution log managed by the database monitor; whereby access to an unencrypted representation of the SQL statement via the database monitor requires decryption of the encrypted representation of the SQL statement stored in the execution log.

2. The method of claim 1, further comprising encrypting at least one value passed to one of a host variable and a parameter marker used by the SQL statement, wherein logging execution of the SQL statement further comprises storing the encrypted value in the execution log.

3. A method of logging query execution in a database management system, the method comprising:
generating an encrypted representation of an execution detail for a query executed by the database management system; and
logging the execution detail for the query in an execution log for the database management system by storing the encrypted representation thereof in the execution log.

4. The method of claim 3, further comprising receiving the query in an unencrypted form from an application program in communication with the database management system.

5. The method of claim 4, wherein generating the encrypted representation is performed after communicating the query to the database management system.

6. The method of claim 3, wherein generating the encrypted representation is performed prior to communicating the query to the database management system.

7. The method of claim 3, wherein the execution detail comprises a query statement.

8. The method of claim 3, wherein the execution detail comprises a value passed to a host variable during execution of the query.

9. The method of claim 3, wherein the execution detail comprises a value passed to a parameter marker during execution of the query.

10. The method of claim 3, further comprising logging a second execution detail for the query in the execution log in an unencrypted representation.

11. The method of claim 10, wherein the second execution detail includes at least one of an access plan and a performance statistic associated with execution of the query.

12. The method of claim 3, further comprising decrypting the execution detail in association with displaying the execution log.

13. The method of claim 12, wherein generating the encrypted representation includes encrypting the execution detail using a public key, and wherein decrypting the execution detail includes decrypting the execution detail using a private key paired with the public key.

14. The method of claim 3, further comprising determining if database monitoring is enabled in the database management system, wherein generating the encrypted representation is performed if it is determined that database monitoring is enabled.

15. The method of claim 3, wherein the query comprises an SQL statement.

16. An apparatus, comprising:
at least one processor;
a memory within which is stored an execution log; and
program code configured to be executed by the at least one processor to log query execution in a database management system by generating an encrypted representation of an execution detail for a query executed by the database management system, and logging the execution detail for the query in the execution log by storing the encrypted representation thereof in the execution log.

17. The apparatus of claim 16, wherein the program code is further configured to receive the query in an unencrypted form from an application program in communication with the database management system.

18. The apparatus of claim 17, wherein the program code is configured to generate the encrypted representation after communicating the query to the database management system.

19. The apparatus of claim 16, wherein the program code is configured to generate the encrypted representation prior to communicating the query to the database management system.

20. The apparatus of claim 16, wherein the execution detail comprises a query statement.

21. The apparatus of claim 16, wherein the execution detail comprises a value passed to a host variable during execution of the query.

22. The apparatus of claim 16, wherein the execution detail comprises a value passed to a parameter marker during execution of the query.

23. The apparatus of claim 16, wherein the program code is further configured to log a second execution detail for the query in the execution log in an unencrypted representation.

24. The apparatus of claim 23, wherein the second execution detail includes at least one of an access plan and a performance statistic associated with execution of the query.

25. The apparatus of claim 16, wherein the program code is further configured to decrypt the execution detail in association with displaying the execution log.

26. The apparatus of claim 25, wherein the program code is configured to generate the encrypted representation by encrypting the execution detail using a public key, and wherein the program code is configured to decrypt the execution detail by decrypting the execution detail using a private key paired with the public key.

27. The apparatus of claim 16, wherein the program code is further configured to determine if database monitoring is enabled in the database management system, and wherein the program code is configured to generate the encrypted representation if it is determined that database monitoring is enabled.

28. The apparatus of claim 16, wherein the query comprises an SQL statement.

29. A program product, comprising:
program code configured to log query execution in a database management system by generating an encrypted representation of an execution detail for a query executed by the database management system, and logging the execution detail for the query in an execution log for the database management system by storing the encrypted representation thereof in the execution log; and
a computer readable signal bearing medium bearing the program code.

30. The program product of claim 29, wherein the computer readable signal bearing medium includes at least one of a transmission medium and a recordable medium.
